(19) United States
(12) Patent Application Publication
(10) Pub. No.: US 2019/0314869 A1
(43) Pub. Date: Oct. 17, 2019

(54) APPARATUS FOR MOUNTING A HOSE OF A VACUUM SYSTEM OR A BLOWING SYSTEM APPARATUS

(71) Applicant: MULTIHOG R&D LIMITED, County Louth (IE)

(72) Inventors: James MCADAM, County Louth (IE); Samuel HAMPSHIRE, County Meath (IE); Daniel MCELCHAR, County Donegal (IE); Gerard MCHUGH, County Managhan (IE)

(73) Assignee: MULTIHOG R&D LIMITED, County Louth (IE)

(21) Appl. No.: 16/463,642

(22) PCT Filed: Nov. 27, 2017
(86) PCT No.: PCT/EP2017/080496

§ 371 Date: May 23, 2019

(30) Foreign Application Priority Data
Nov. 25, 2016 (IE) S2016/0264

(51) Int. Cl. B08B 5/02; E01H 1/08

(52) U.S. Cl. CPC B08B 5/02; E01H 1/0809

(57) ABSTRACT

Apparatus on a driver's cab roof mounts a hose terminating in a nozzle of a vacuum system. The apparatus includes a proximal carrier arm pivotally mounted on the cab roof about a vertically extending main pivot axis by a slewing mechanism. A distal carrier arm is pivotally coupled to the proximal carrier arm about a transversely extending horizontal first pivot axis. A first ram pivots the distal carrier arm upwardly and downwardly relative to the proximal carrier arm. The distal carrier arm is extendable between its proximal end and its distal end by a second ram. By pivoting the proximal carrier arm by the slewing mechanism, the nozzle is urged from one side of the vehicle to the other. By pivoting the distal carrier arm upwardly relative to the proximal carrier arm, and simultaneously extending the distal carrier arm, the reach of the nozzle is increased.

The present invention relates to apparatus for mounting a hose of one of a vacuum system and a blower system on a wheeled work vehicle, and the invention also relates to a wheeled work vehicle comprising the apparatus. Additionally, the invention relates to a wheeled work vehicle comprising one of a vacuum system and a blower system mounted thereon, and a hose of the one of the vacuum system and the blower system mounted on the wheeled work vehicle by the apparatus.

Wheeled work vehicles for vacuuming litter, rubbish and other debris from roads, footpaths, parks and other surfaces are known. In general, such wheeled work vehicles are used by municipal authorities, such as local authorities, County Councils and the like. Typically, such wheeled work vehicles for vacuuming litter, rubbish and other debris are provided with a vacuum system which includes a holding container for holding the vacuumed litter, rubbish and other debris, and a vacuum hose extending from the holding container and terminating at its distal end in a nozzle, through which the litter, rubbish and other debris is drawn from the ground into the vacuum hose. Typically, the nozzle is located beneath the wheeled work vehicle, or to one side of the wheeled work vehicle behind the driver's cab, and in general is not visible to the driver. This, is quite a disadvantage, since once the litter, rubbish or debris has passed out of the line of sight of the driver, the driver cannot be sure that the nozzle is correctly aligned with the litter, rubbish or other debris for vacuuming from the ground. A further disadvantage of such wheeled work vehicles is that once the litter, rubbish and other debris has passed out of the line of sight of the driver as the vehicle is being driven forwardly, the only facility available to the driver to check if the the litter, rubbish or other debris has been drawn into the vacuum hose is by viewing the path traversed by the wheeled work vehicle in the rear view mirror or mirrors of the vehicle. This is unsatisfactory, since some litter, rubbish and debris may be of a size which would be too small to be easily visible in the rear view mirror or mirrors of the vehicle. Furthermore, the requirement to have a driver continuously check the rear view mirror or mirrors to ascertain if all the litter, rubbish and debris has been drawn into the vacuum hose, results in the driver being distracted from looking ahead, which can thus result in serious accidents. A further disadvantage of such wheeled work vehicles is that litter, rubbish and other debris can only be vacuumed from the area of the ground which is within the path traversed by the vehicle, there is no provision in such wheeled work vehicles to vacuum litter, rubbish and other debris from areas to either side of the path traversed by the vehicle.

There is therefore a need for a wheeled work vehicle which addresses at least some of these problems, and there is also a need for apparatus for mounting a hose of a vacuum system of a wheeled work vehicle on the vehicle, which also addresses at least some of these problems.

The present invention is directed towards providing such an apparatus and a wheeled work vehicle.

According to the invention there is provided apparatus for mounting a hose of one of a vacuum system and a blower system on a wheeled work vehicle, the hose terminating at a distal end in a distal opening, the apparatus comprising a mounting means configured for mounting on a cab of the wheeled work vehicle, a carrier means for carrying the hose, the carrier means being pivotally coupled to the mounting means and being pivotal about a main pivot axis from a first state locating the distal opening of the hose to a first side of the work vehicle, and a second state locating the distal opening of the hose to a second side of the work vehicle, and a main urging means for urging the carrier arm between the respective first and second states.

Preferably, a securing means is provided for securing the hose to the carrier means. Advantageously, the securing means comprises a releasable securing means for releasably securing the hose to the carrier means.

In one aspect of the invention the carrier means terminates in a distal securing means for securing the hose to the carrier means adjacent the distal end of the carrier means. Preferably, the distal securing means comprises a releasable distal securing means for releasably securing the hose to the carrier means adjacent the distal end thereof. Advantageously, the distal securing means is configured for securing the hose to the carrier means towards the distal opening of the hose.

In another aspect of the invention the carrier means is configured for moving the distal opening of the hose from the first side of the work vehicle to the second side thereof across and in front of the cab as the carrier means is urged between the first and second states through a central state intermediate the first and second states with the carrier means extending in a generally forwardly direction relative to the normal forward direction of motion of the vehicle. Preferably, the mounting means is configured for mounting on the cab of the wheeled work vehicle with the main pivot axis extending substantially vertically. Advantageously, the mounting means is configured for mounting on the roof of the cab of the wheeled work vehicle externally of the cab.

In another aspect of the invention the carrier means comprises a proximal carrier arm extending between a proximal end and a distal end and a distal carrier arm extending between a proximal end and a distal end, the proximal carrier arm being pivotally connected to the mounting means about the main pivot axis adjacent the proximal end thereof. Preferably, the proximal end of the distal carrier arm is connected to the distal end of the proximal carrier arm. Advantageously, the distal carrier arm extends in a generally downwardly direction from the proximal carrier arm.

Preferably, the distal carrier arm is pivotally coupled to the proximal carrier arm about a first pivot axis, and is pivotal about the first pivot axis from a first position extending generally downwardly from the proximal carrier arm through an angle relative to the proximal carrier arm with the distal carrier arm extending in a generally forwardly downwardly direction when the carrier means is in the central state.

In one aspect of the invention a first urging means is provided for pivoting the distal carrier arm relative to the proximal carrier arm about the first pivot axis.

Preferably, the distal carrier arm is pivotally coupled to the proximal carrier arm about a second pivot axis extending substantially orthogonally to the first pivot axis, and is pivotal about the second pivot axis from side to side out of a substantially vertically extending plane containing the proximal carrier arm. Advantageously, the distal carrier arm is resiliently retained in the substantially vertically extending plane containing the proximal carrier arm. Preferably, a resilient retaining means is coupled between the distal carrier arm and the proximal carrier arm for resiliently retaining the distal carrier arm in the substantially vertically extending plane containing the proximal carrier arm. Advantageously, the resilient retaining means comprises a pair of tension springs coupled between the proximal and distal carrier arms on respective opposite sides of the second pivot axis.

Preferably, the proximal carrier arm extends substantially horizontally. Advantageously, the distal securing means is located on the distal carrier arm adjacent the distal end thereof.

In one aspect of the invention the distal carrier arm is extendable and contractible between the proximal and distal ends thereof.

Preferably, the distal carrier arm comprises a proximal part and a distal part, one of the proximal part and the distal part being slideable relative to the other one of the proximal part and the distal part in a guide means located on the other one of the proximal part and the distal part for extending and contracting the distal carrier arm.

In one aspect of the invention the distal part of the distal carrier arm is resiliently mounted relative to the proximal part thereof for facilitating flexing of the distal end of the distal carrier arm relative to the proximal end thereof.

In another aspect of the invention the one of the proximal part and the distal part of the distal carrier arm comprises an outer telescoping member forming the guide means, and the other one of the proximal part and the distal part of the distal carrier arm comprises an inner telescoping member slideable in the outer telescoping member.

In another aspect of the invention the proximal part of the distal carrier arm comprises the outer telescoping member, and the distal part of the distal carrier arm comprises the inner telescoping member. Preferably, the inner telescoping member comprises a resilient material for permitting flexing of the inner telescoping member. Advantageously, the inner telescoping member comprises a resilient plastics material.

In another aspect of the invention the distal carrier arm comprises a pair of outer telescoping members and a corresponding pair of inner telescoping members extending parallel to each other.

Preferably, a second urging means is provided for urging the proximal and distal parts of the distal carrier arm towards and away from each other for contracting and extending the distal carrier arm between the proximal and distal ends thereof. Advantageously, the second urging means is pivotally coupled to the proximal part of the distal carrier arm for accommodating flexing of the distal part of the distal carrier arm relative to the proximal part thereof.

Preferably, a plurality of the securing means is provided spaced apart on the carrier means for securing the hose to the carrier means at spaced apart locations along the carrier means.

In another aspect of the invention the mounting means is configured for resiliently mounting on the roof of the cab by a resilient mounting means. Preferably, the resilient mounting means comprises at least two spaced apart resilient mounting elements. Advantageously, the resilient mounting means comprises four spaced apart resilient mounting elements. Preferably, the mounting means comprises a mounting plate.

In one aspect of the invention the main urging means comprises a slewing mechanism mounted on the mounting means and defining the main pivot axis. Preferably, the slewing mechanism comprises a slewing element having external gear teeth engageable with a worm gear for pivoting the slewing element about the main pivot axis, the carrier means being coupled to the slewing element for urging the carrier means between the first and second states. Advantageously, the worm gear is driven by a drive motor.

The invention also provided a wheeled work vehicle comprising a chassis, a pair of spaced apart forward ground engaging wheels rotatably mounted on the chassis adjacent the forward end thereof, and a pair of spaced apart rearward ground engaging wheels rotatably mounted on the chassis adjacent the rearward end thereof, a cab mounted on the chassis adjacent the forward end thereof, one of a vacuum system and a blower system located on the chassis, and a hose extending from the one of the vacuum system and the blower system, the hose terminating at a distal end thereof in a distal opening, and apparatus according to the invention with the mounting means of the apparatus mounted on the cab and the hose secured to the carrier means.

In one aspect of the invention the mounting means is mounted on the roof of the cab.

In another aspect of the invention the mounting means is mounted on the cab of the vehicle with the main pivot axis extending substantially vertically.

In another aspect of the invention the carrier means and the mounting means are configured so that the carrier means is pivotal relative to the mounting means about the main pivot axis from the first state with the distal opening of the hose located to one side of the cab to the second state with the distal opening of the hose located adjacent the other side of the cab. Preferably, the mounting means is mounted on the cab, so that as the carrier means is being pivoted about the main pivot axis from the first state to the second state through the central state, the distal opening of the hose is urged from one side of the cab to the other side thereof in front of the cab and externally thereof.

Advantageously, an engine is provided in the wheeled work vehicle.

In one aspect of the invention the chassis comprises a forward chassis part and rearward chassis part pivotally coupled to the forward chassis part about a substantially vertically extending primary pivot axis about which the forward chassis part and the rearward chassis part are pivotal relative to each other for steering of the wheeled work vehicle.

In another aspect of the invention the cab is mounted on the forward chassis part, and the one of the vacuum system and the blower system is mounted on the rearward chassis part.

Preferably, at least one primary urging means is coupled between the forward and rearward chassis parts for pivoting the one of the forward and rearward chassis parts relative to the other one of the forward and rearward chassis parts for steering the wheeled work vehicle. Advantageously, the primary urging means is located to one side of the primary pivot axis. Preferably, a pair of the primary urging means are provided on respective opposite sides of the primary pivot axis.

Preferably, the one of the vacuum system and the blower system is located on the rearward chassis part. Advantageously, the engine is mounted on the rearward chassis part. Preferably, the one of the vacuum system and the blower system is located above the engine.

In one aspect of the invention the hose is mounted on the carrier means by the securing means.

In another aspect of the invention the distal opening of the hose is defined by a distal nozzle in which the distal end of the hose terminates.

Preferably, the hose is secured to the distal end of the carrier means by the distal securing means.

In one aspect of the invention the vacuum system comprises a holding container and a vacuum drawing means located in or adjacent the holding container for drawing a vacuum in the holding container, and the hose is coupled to and communicates with the holding container through an inlet port.

In one aspect of the invention the engine is configured to drive the rearward ground engaging wheels.

In another aspect of the invention the engine is configured to drive the forward ground engaging wheels.

In a further aspect of the invention the engine is configured to drive the ground engaging wheels through an hydraulic transmission system.

Preferably, a control means is provided for controlling the operation of the main urging means. Advantageously, the control means is configured for controlling the operation of the first urging means. Preferably, the control means is configured for controlling the second urging means.

Advantageously, the control means is responsive to one or more manually operated elements for controlling the main urging means, the first urging means and the second urging means.

In one aspect of the invention the first urging means comprises a first hydraulic ram.

In another aspect of the invention the second urging means comprises a second hydraulic ram.

In a further aspect of the invention the vacuum system and the hose are configured for drawing litter, rubbish and other debris from any one of a roadway, a pathway, a park, a recreational area or any other area or surface where litter, rubbish or other debris may collect.

The advantages of the invention are many. By virtue of the fact that the apparatus according to the invention is configured for mounting on the driver's cab of a wheeled work vehicle, and furthermore, is configured for locating the hose and the distal opening thereof forwardly and from side to side of the wheeled work vehicle, the driver while looking ahead also has a clear field of view of litter, rubbish and other debris which is to be drawn into the hose through the distal opening thereof, and can move the hose and in turn the distal opening thereof in order to vacuum up the litter, rubbish and other debris. Additionally, by virtue of the fact that the driver while still looking ahead has a clear field of view of the area after the litter has been drawn into the hose, the driver can readily check if all litter, rubbish and debris has been collected.

A further and important advantage of the invention is that the hose and the distal opening thereof can be urged from side to side of the wheeled work vehicle as the wheeled work vehicle is driven forwardly, so that litter, rubbish and debris both in front of the vehicle and to the sides of the vehicle, which are beyond the path traversed by the vehicle can also be drawn into the hose through the distal opening.

A particularly important advantage of the invention is achieved when the apparatus is used for mounting a hose of a vacuum system on the cab of a wheeled work vehicle of the type which comprises a forward chassis part and a rearward chassis part which are pivotally connected about a substantially vertically extending primary pivot axis for steering of the wheeled work vehicle. By virtue of the fact that the hose is mounted by the apparatus on the cab of the wheeled work vehicle, which is normally located on the forward chassis part of the wheeled work vehicle, the position of the hose and in turn the distal opening thereof does not alter relative to the cab of the wheeled work vehicle during steering of the wheeled work vehicle.

A further advantage of the invention is that the reach of the hose and the distal opening thereof can be varied and can be considerably extended from the cab of the wheeled work vehicle, and in particular, to either side of the cab of the wheeled work vehicle. This is achieved by virtue of the fact that the carrier means comprises a proximal carrier arm, and a distal carrier arm and the distal carrier arm is pivotally coupled to the proximal carrier arm about a first pivot axis, and the distal carrier arm is extendable.

The invention will be more clearly understood from the following description of a preferred embodiment thereof, which is given by way of example with reference to the accompanying drawings, in which:

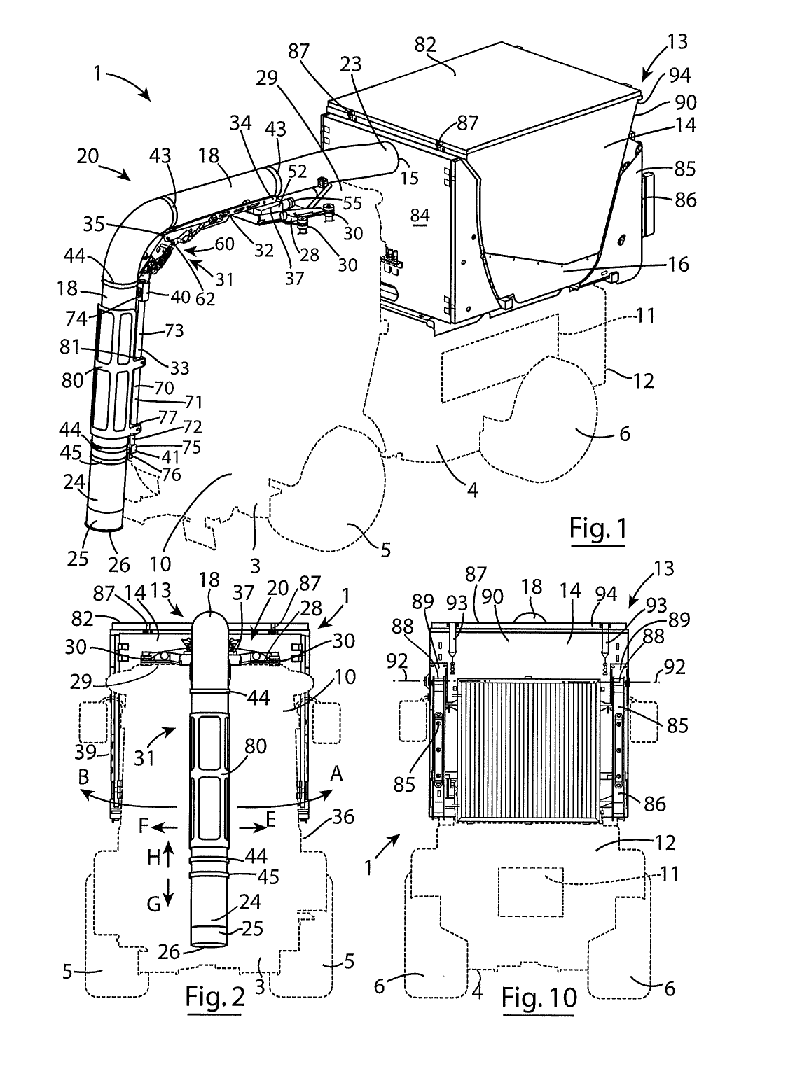

FIG. 1 is a perspective view of a wheeled work vehicle according to the invention comprising apparatus also according to the invention for mounting a hose of a vacuum system or a blowing system on the wheeled work vehicle,

FIG. 2 is a front elevational view of the wheeled work vehicle of FIG. 1,

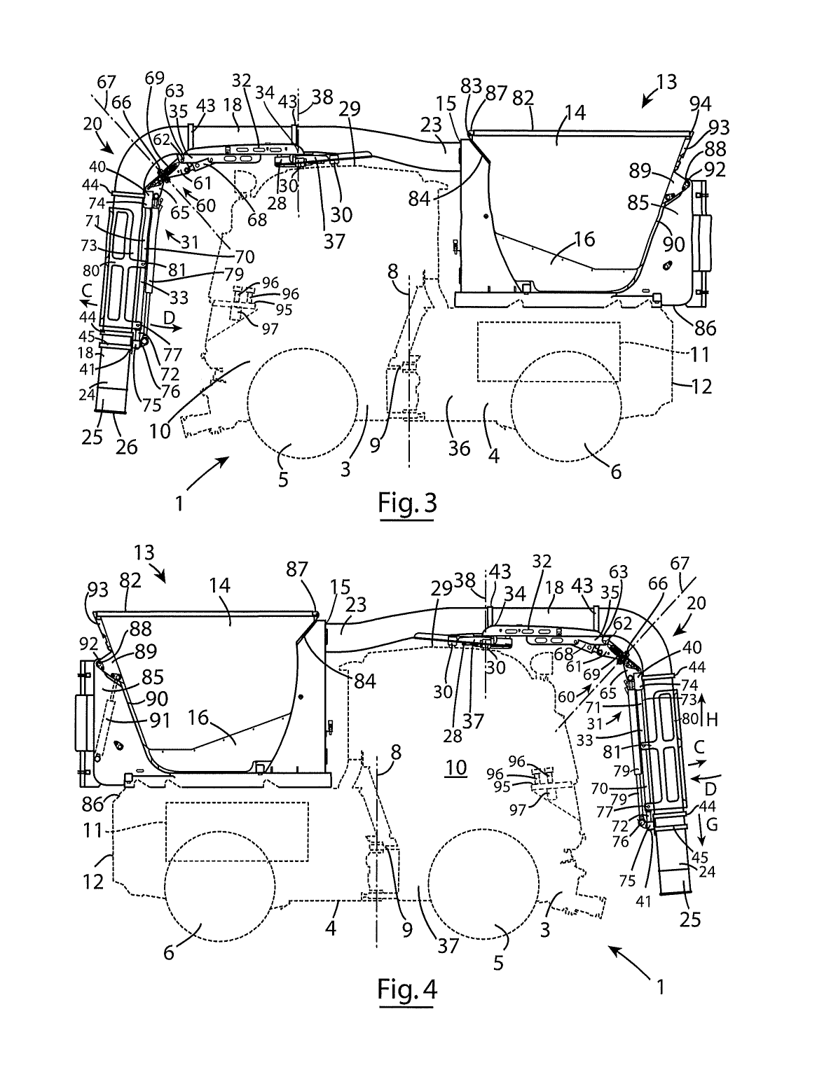

FIG. 3 is a side elevational view of the wheeled work vehicle of FIG. 1,

FIG. 4 is a side elevational view of the wheeled work vehicle of FIG. 1 from the other side to that of FIG. 3,

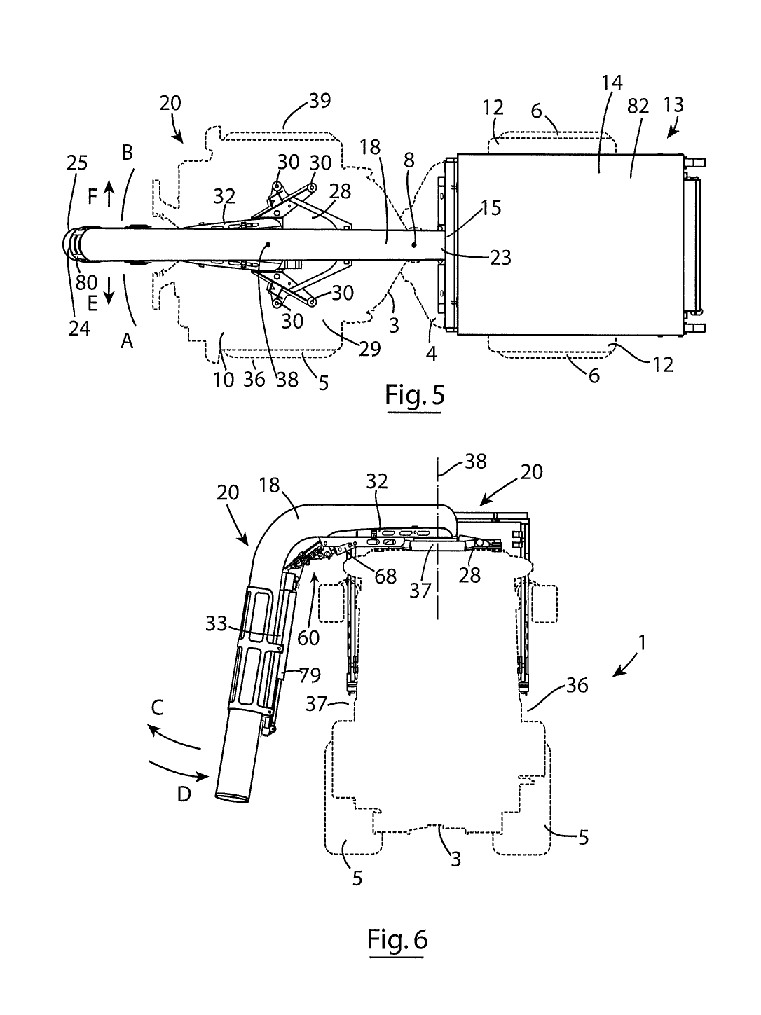

FIG. 5 is a top plan view of the wheeled work vehicle of FIG. 1,

FIG. 6 is front elevational view of the wheeled work vehicle of FIG. 1 with the apparatus in a different state to that of FIG. 1,

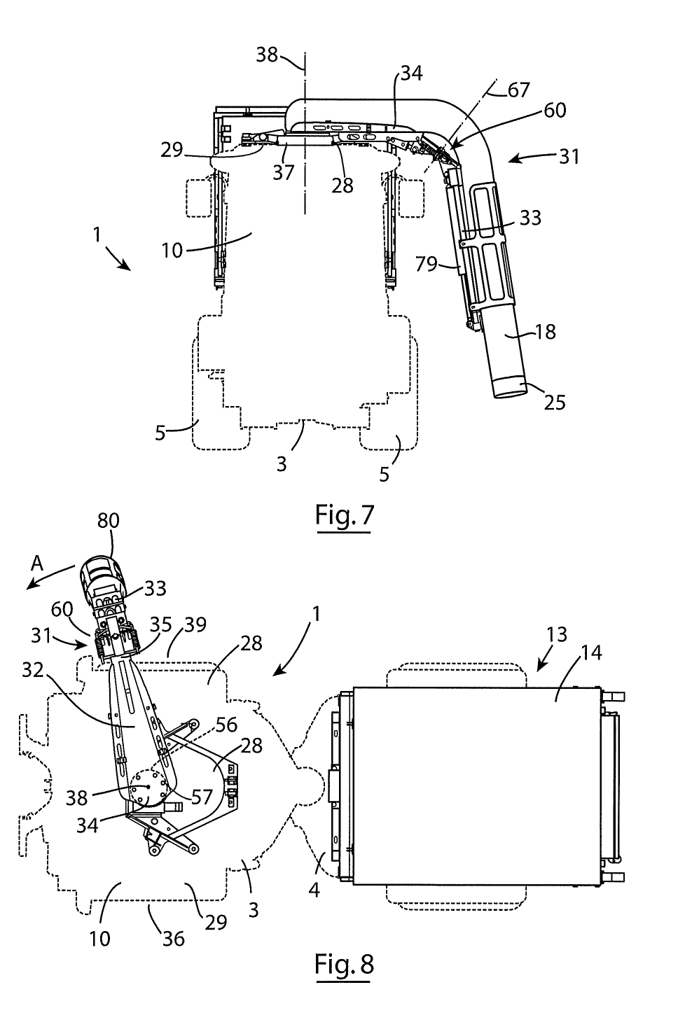

FIG. 7 is a front elevational view of the wheeled work vehicle of FIG. 1, with the apparatus in a further different state to that of FIG. 1,

FIG. 8 is a top plan view of the wheeled work vehicle of FIG. 1 with the apparatus in the state of FIG. 6,

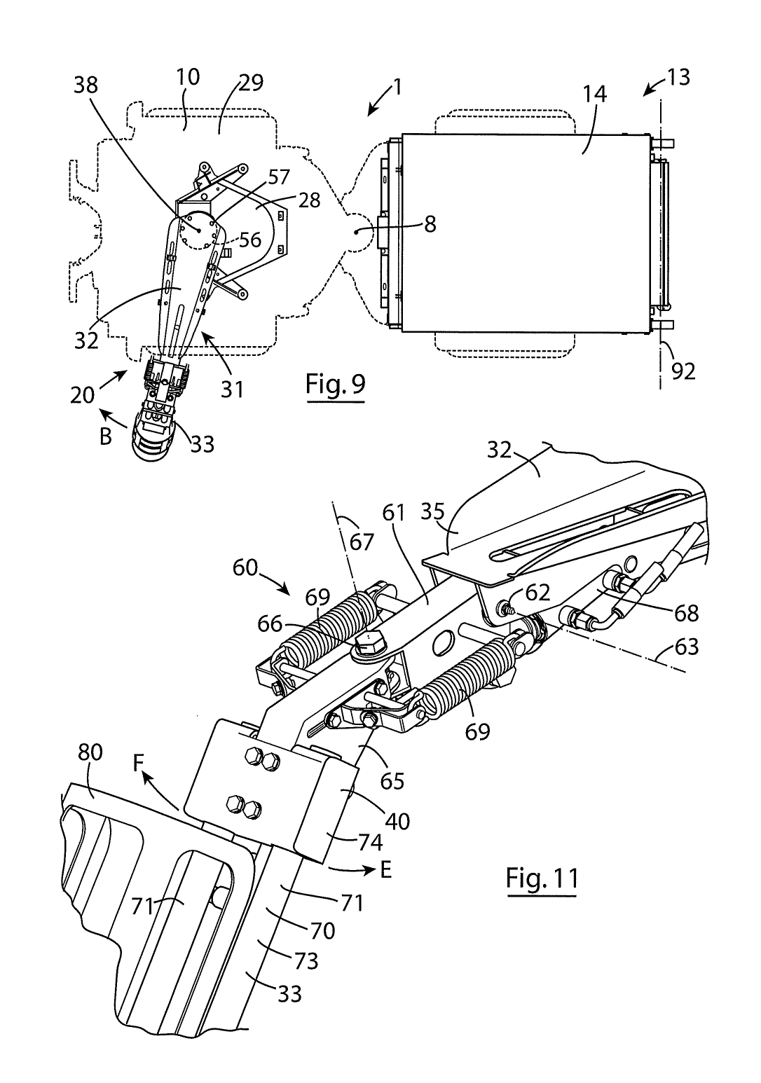

FIG. 9 is a top plan view of the wheeled work vehicle of FIG. 1, with the apparatus in the state of FIG. 7,

FIG. 10 is a rear end elevational view of the wheeled work vehicle of FIG. 1,

FIG. 11 is an enlarged perspective view of a detail of a portion of the apparatus of the wheeled work vehicle of FIG. 1,

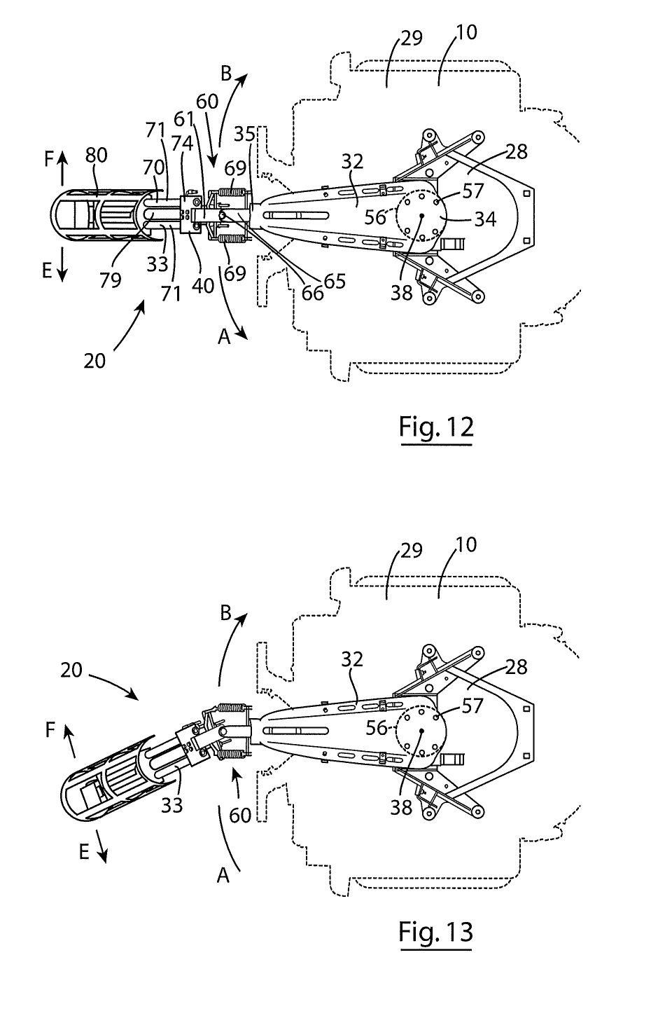

FIG. 12 is a top plan view of a portion of the wheeled work vehicle and the apparatus of FIG. 1,

FIG. 13 is a top plan view of the portion of the wheeled work vehicle of FIG. 12 illustrating the apparatus of FIG. 1 in a different state to that of FIG. 12,

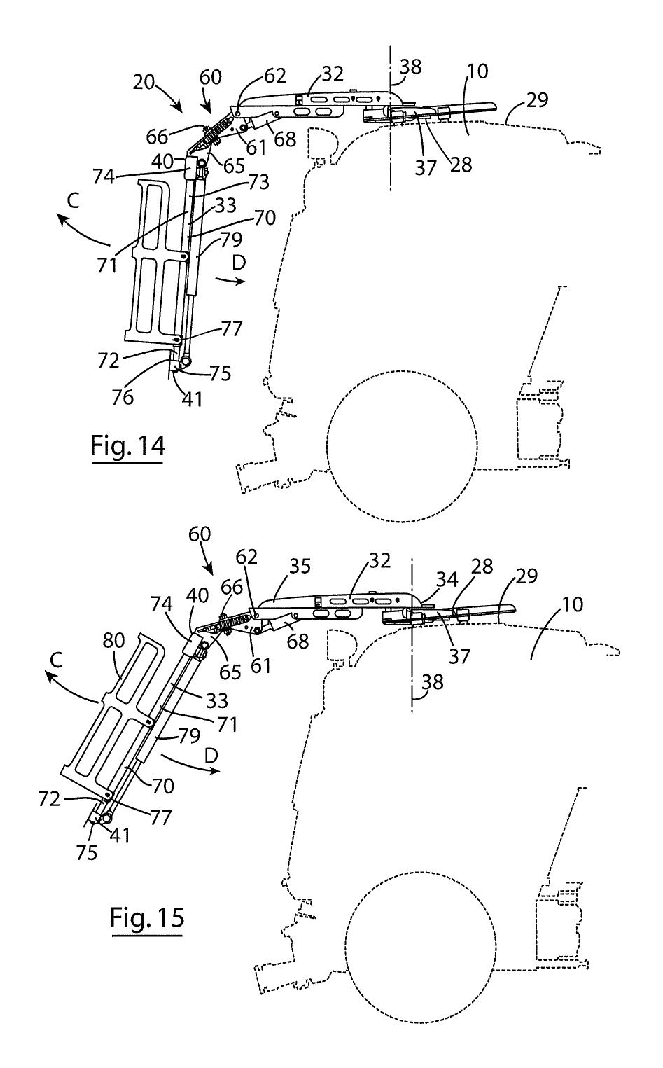

FIG. 14 is a side elevational view of the portion of the wheeled work vehicle of FIG. 12 and of the apparatus of FIG. 1,

FIG. 15 is a view similar to FIG. 14 of the portion of FIG. 12 of the wheeled work vehicle of FIG. 1 with the apparatus of FIG. 1 in a different state to that of FIG. 14,

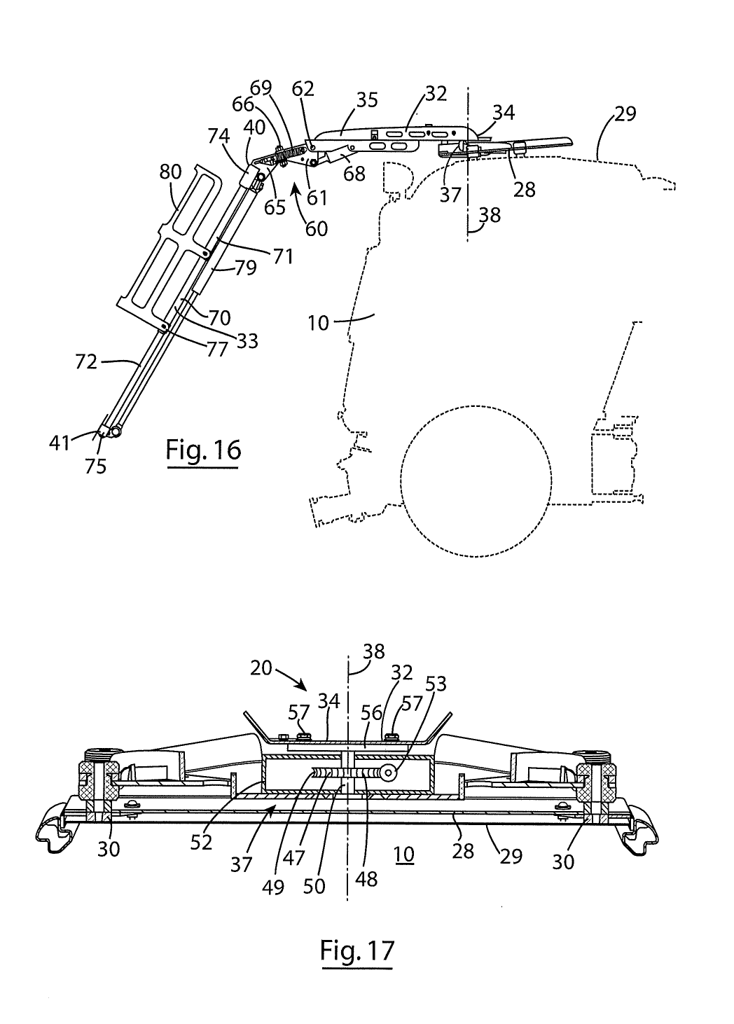

FIG. 16 is a side elevational view of the portion of FIG. 12 of the wheeled work vehicle of FIG. 1 illustrating the apparatus of FIG. 1 in a different state to that of FIGS. 14 and 15, and

FIG. 17 is a transverse cross-sectional view of a portion of the roof of the cab of the work vehicle of FIG. 1 and a portion of the apparatus of FIG. 1.

Referring to the drawings there is illustrated a wheeled work vehicle according to the invention indicated generally by the reference numeral 1 configured for vacuuming litter, rubbish and other debris from the ground, and may also be configured for blowing litter, rubbish and other debris, for example, fallen leaves into piles for subsequent collection. The wheeled work vehicle 1 comprises a chassis formed by a forward chassis part 3 and rearward chassis part 4. A pair of spaced apart forward ground engaging wheels 5 are rotatably mounted on the forward chassis part 3. A pair of spaced apart rearward ground engaging wheels 6 are rotatably mounted on the rearward chassis part 4. The forward and rearward chassis parts 3 and 4 are pivotally coupled together about a substantially vertically extending primary pivot axis 8 for facilitating steering of the work vehicle 1. A primary urging means for pivoting one of the forward chassis part 3 and the rearward chassis part 4 relative to each other for steering the work vehicle 1, in this embodiment of the invention comprises a pair of hydraulically powered steering rams 9 coupled between the forward and rearward chassis parts 3 and 4 on respective opposite sides of the primary pivot axis 8.

A driver's cab 10 is mounted on the forward chassis part 3. An engine 11 is mounted on the rearward chassis part 4, and is housed in a housing 12 located on the rearward chassis part 4. In this embodiment of the invention the forward and rearward ground engaging wheels 5 and 6 are driven by the engine 11 through an hydraulic transmission system (not shown) whereby each of ground engaging wheels 5 and 6 is driven by a corresponding hydraulic motor (also not shown). However, it will be readily appreciated by those skilled in the art that in certain cases only the rear ground engaging wheels 6 may be driven, or alternately, only the forward ground engaging wheels 5 may be driven. It will also be readily appreciated by those skilled in the art that the forward and/or rearward ground engaging wheels 5 and 6 may be driven by the engine 11 through a suitable mechanical drive transmission system.

The construction and operation of such work vehicles comprising a forward chassis part and a rearward chassis part which are steerable by a pair of steering rams will be well known to those skilled in the art, and further description should not be required.

In this embodiment of the invention the wheeled work vehicle 1 comprises a vacuum system 13 for vacuuming up litter, rubbish and other debris from roads, pavements and other surfaces. The vacuum system 13 comprises a holding container 14 mounted on the housing 12 for receiving and collecting the litter, rubbish and other debris through an inlet port 15. A vacuum drawing unit 16 attached to the holding container 14 and communicating therewith is provided for drawing a vacuum in the holding container 14 for drawing the litter, rubbish and other debris into the holding container 14 through the inlet port 15.

An elongated hose 18 is carried on apparatus according to the invention which is indicated generally by the reference numeral 20, and which will be described in detail below. The hose 18 extends between a proximal end 23 and a distal end 24. Since wheeled work vehicles of the type of the wheeled work vehicle 1 will be well known to those skilled in the art, the wheeled work vehicle 1 is illustrated in broken lines only. However, the apparatus 20, the vacuum system 13 and the hose 18 are illustrated in full lines.

The proximal end 23 of the hose 18 is connected to the inlet port 15 of the holding container 14, and the distal end 24 of the hose 18 terminates in a nozzle 25 which defines a distal opening, namely, a distal inlet port 26 through which the litter, rubbish and other debris is drawn into the hose 18, and in turn through the hose 18 and the inlet port 15 into the holding container 14 by the vacuum drawn in the holding container 14 by the vacuum drawing unit 16. In this embodiment of the invention the hose 18 is of a flexible plastics material of concertina construction which is reinforced by a helically coiled reinforcing wire, and is extendable and contractible longitudinally between its proximal end 23 and its distal end 24. In order to be of size sufficient to collect the litter, rubbish and other debris, in this embodiment of the invention the hose is of an internal diameter of approximately 200mm, and the diameter of the distal inlet port 26 defined by the nozzle 25 is also approximately 200mm. However, it will be readily apparent to those skilled in the art that the diameter of the hose 18 and the distal inlet port 26 may be of any suitable diameter, and typically would lie in the range of 50mm to 300mm, and in general would lie in the range of 150 mm to 250 mm.

The apparatus 20 comprises a mounting means, namely, a mounting plate 28 which is mounted on the roof 29 of the driver's cab 10 by resilient mounting means, in this embodiment of the invention four spaced apart rubber mountings 30. A carrier means for carrying the hose 18 comprises a carrier 31, which in this embodiment of the invention comprises an elongated proximal carrier arm 32 and an elongated distal carrier arm 33 which is coupled to the proximal carrier arm 32, as will be described below. The proximal carrier arm 32 extends between a proximal end 34 and a distal end 35, and is pivotally coupled to the mounting plate 28 through a slewing mechanism 37 adjacent the proximal end 34 thereof. The slewing mechanism 37 defines a substantially vertically extending main pivot axis 38 about which the proximal carrier arm 32, and in turn the distal carrier arm 33 are pivotal in the directions of the arrows A and B between a first state illustrated in FIGS. 7 and 9 with the distal end 24 of the hose 18 and the nozzle 25 located to one side, namely, a first side 36 of the vehicle 1, and a second state illustrated in FIGS. 6 and 8 with the hose 18 and the nozzle 25 located to the other side, namely, a second side 39 of the vehicle 1, as will be described in more detail below. The distal carrier arm 33 extends between a proximal end 40 and a distal end 41. The proximal end 40 of the distal carrier arm 33 is coupled to the distal end 35 of the proximal carrier arm 32 as will be described below.

The hose 18 is releasably secured to the proximal carrier arm 32 by releasable securing means, namely, a pair of spaced apart releasable securing straps 43 which extend around and secure the hose 18 to the proximal carrier arm 32. The hose 18 is also releasably secured to the distal carrier arm 33 by releasable securing means, namely, one releasable securing strap 44 which extends around the hose 18 and secures the hose 18 to the proximal end 40 of the distal carrier arm 33. A distal securing means for releasably securing the hose 18 to the distal end 41 of the distal carrier arm 33 comprises a releasable distal securing means, namely, a distal securing strap 45 which extends around the hose 18 and releasably secures the hose 18 to the distal end 41 of the distal carrier arm 33.

Turning now to the slewing mechanism 37, the slewing mechanism 37 comprises a slewing gear 47 having external gear teeth 48 around the periphery 49 thereof. The slewing gear 47 is mounted concentrically and fast on a substantially vertically extending main shaft 50, which is rotatably mounted in a gear housing 52 about the main pivot axis 38. A worm gear 53 rotatably mounted in the housing 52 is engageable with the slewing gear 47 for rotating the slewing gear 47 for in turn pivoting the main shaft 50 about the main pivot axis 38. A main urging means, namely, an hydraulically powered main motor 55 is coupled to the worm gear 53 for driving the slewing gear 47 for in turn pivoting the main shaft 50 about the main pivot axis 38. A mounting disc 56 is mounted fast on the main shaft 50 adjacent the top thereof, and is concentric with the main shaft 50. The proximal carrier arm 32 is rigidly secured to the mounting disc 56 by screws 57, and extends radially and substantially horizontally from the main shaft 50. By alternately rotating the worm gear 53 clockwise and anticlockwise, the slewing gear 47 and the main shaft 50 are pivoted about the main pivot axis 38, which in turn urges the proximal carrier arm 32 and the distal carrier arm 33 between the first state with the nozzle 25 and the hose 18 to the first side 36 of the wheeled work vehicle 1, and a second state with the nozzle 25 and the hose 18 located on the second side 39 of the wheeled work vehicle 1, through a central state illustrated in FIGS. 2 and 5 with the proximal carrier arm 32 extending forwardly relative to the normal forward direction of motion of the vehicle 1, and with the nozzle 25 and the hose 18 located in front of the wheeled work vehicle 1.

Turning now to the coupling of the distal carrier arm 33 to the proximal carrier arm 32, the distal carrier arm 33 is coupled to the proximal carrier arm 32 by a pivotal coupling mechanism 60. The pivotal coupling mechanism 60 comprises a proximal part 61 and a distal part 65. The proximal part 61 is pivotally coupled to the proximal carrier arm 32 by a first pivot shaft 62, which extends substantially horizontally, and defines a substantially horizontally extending first pivot axis 63 about which the pivotal coupling mechanism 60 is pivotally coupled to the proximal carrier arm 32, and also about which the distal carrier arm 33 is pivotally coupled to the proximal carrier arm 32. The distal part 65 of the pivotal coupling mechanism 60 extends rigidly from the distal carrier arm 25, and is pivotally coupled by a second pivot shaft 66 to the proximal part 61 of the pivotal coupling mechanism 60. The second pivot shaft 66 defines a second pivot axis 67 about which the distal carrier arm 33 is pivotally coupled to the proximal part 61 of the pivotal coupling mechanism 60, and also to the proximal carrier arm 32. The second pivot axis 67 extends substantially orthogonally relative to the first pivot axis 63, and in an upwardly forwardly direction relative to the direction of normal forward movement of the vehicle 1 when the proximal carrier arm 32 is in the central state extending forwardly from the cab 10 and the main pivot axis 38.

The pivotal coupling of the proximal part 61 of the pivotal coupling mechanism 60 to the proximal carrier arm 32 about the first pivot shaft 63 permits the distal carrier arm 33 to be pivoted in a generally upwardly and downwardly direction, namely, in the directions of the arrows C and D about the first pivot axis 63 relative to the proximal carrier arm 32, see FIGS. 3 and 4 and 14 to 16. This allows the reach of the hose 18, and in turn the nozzle 25 to be increased as will be described below.

The pivotal coupling of the distal part 65 to the proximal part 61 of the pivotal coupling mechanism 60 about the second pivot axis 67 permits pivoting of the distal carrier arm 33 relative to the proximal carrier arm 32 about the second pivot axis 67 in the direction of the arrows E and F from side to side out of a substantially vertically extending plane containing the proximal carrier arm 32, in the event of the nozzle 25 or the distal end 41 of the distal carrier arm 33 encountering an obstacle or an obstruction, as the proximal and distal carrier arms 32 and 33 are being pivoted about the main pivot axis 38 in the directions of the arrows A and B between the first and second states.

A resilient retaining means for resiliently urging the distal carrier arm 33 into the substantially vertically extending plane containing the proximal carrier arm 32 comprises a pair of tension springs 69 of similar resilience, which are coupled between the proximal part 61 and the distal part 65 of the pivotal coupling mechanism 60, on respective opposite sides of the second pivot axis 67. The action of the tension springs 69 acting between the proximal part 61 and the distal part 65 of the pivotal coupling mechanism 60 resiliently maintains and returns the distal carrier arm 33 in the substantially vertically extending plane containing the proximal carrier arm 33, so that the distal carrier arm 33 can pivot resiliently about the second pivot axis 67 in response to the nozzle 25 or the distal end 41 of the distal carrier arm 33 encountering an obstacle or an obstruction as the proximal and distal carrier arms 32 and 33 are being urged between the first and second states about the main pivot axis 38. This allows the distal carrier arm 33 to yield to the obstacle or obstruction engaged by the nozzle 25 or the distal end 41 of the distal carrier arm 33 without damage to the nozzle 25 or the distal carrier arm 33, or damage to the proximal carrier arm 32 or overloading of the slewing mechanism 37.

A first urging means comprising an hydraulically powered first double acting ram 68 acting between the proximal carrier arm 32 and the proximal part 61 of the pivotal coupling mechanism 60 pivots the proximal part 61 of the pivotal coupling mechanism 60 about the first pivot axis 33, and in turn pivots the distal carrier arm 33 relative to the proximal carrier arm 32 about the first pivot axis 63 upwardly and downwardly in the directions of the arrows C and D for in turn extending the reach of the hose 18, and in turn the nozzle 25 from the wheeled work vehicle in a generally forwardly and side to side direction as will be described in more detail below.

Turning now in detail to the distal carrier arm 33, the distal carrier arm 33 is extendable and contractible between the proximal end 40 and the distal end 41 thereof in order to increase the forward and side to side reach of the hose 18, and in turn the nozzle 25. In this embodiment of the invention in order to provide for extension and contraction of the distal carrier arm 33 between the proximal and distal ends 40 and 41, the distal carrier arm 33 comprises a proximal part 73 and a distal part 76, which in this embodiment of the invention are provided by a proximal cross-member 74 and a distal cross-member 75 which are joined by a pair of telescoping elements 70. The proximal and distal cross-members 74 and 75 define the proximal and distal ends 40 and 41, respectively, of the distal carrier arm 33. The telescoping elements 70 comprise respective outer telescoping members 71, which with the proximal cross-member 74 form the proximal part 73, and respective inner telescoping members 72, which with the distal cross-member 75 form the distal part 76. The outer telescoping members 71 are of tubular steel of circular transverse cross-section, and are rigidly secured to and extend from the proximal cross-member 74. The proximal cross-member 74 is rigidly secured to the distal part 65 of the pivotal coupling mechanism 60. The inner telescoping members 72 are rigidly secured to and extend from a distal cross-member 75. The inner telescoping members 72 are slideable inwardly and outwardly in the corresponding outer telescoping members 71, which form a guide means for guiding the distal part 76 of the distal carrier arm 33 relative to the proximal part 73 thereof in the directions of the arrows G and H during extending and contracting of the distal carrier arm 33.

Each inner telescoping member 72 is of circular transverse cross-section of diameter to permit smooth sliding engagement between the inner telescoping member 72 and the corresponding outer telescoping member 71. In this embodiment of the invention the inner telescoping members 72 are of a resilient plastics material which is of sufficient rigidity to support the distal cross-member 75 as well as the hose 18 and the nozzle 25 without bending, but is of sufficient resilience to permit bending or flexing of the inner telescoping members 72 in the event of the nozzle 25 or the distal end 41 of the distal carrier arm 33 encountering an obstacle or other obstruction during movement of the nozzle 25 and the distal end 41 of the distal carrier arm 33. Bending or flexing of the inner telescoping member 72 in the event of the nozzle 25 or the distal end 41 of the distal carrier arm 33 encountering an obstacle or other obstruction permits yielding of the distal carrier arm 33 in order to avoid damage thereto.

An intermediate cross-member 77 joins the outer telescoping members 71 adjacent the distal end thereof, so that the outer telescoping members 71 are retained parallel by the intermediate cross-member 77 and the proximal cross-member 74. The distal cross-member 75 to which the inner telescoping members 72 are secured retains the inner telescoping members 72 parallel.

A second urging means, which in this embodiment of the invention comprises a second double acting hydraulic ram 79 acting between the proximal cross-member 74 and the distal cross-member 75 urges the distal cross-member 75 relative to the proximal cross-member 74 in the directions of the arrows G and H for extending and contracting the distal carrier arm 33. By operating the first ram 68 to pivot the distal carrier arm 33 upwardly in the direction of the arrow C, and simultaneously operating the second ram 79 to urge the distal cross-member 75 in the direction of the arrow G from the proximal cross-member 74 to extend the length of the distal carrier arm 33, the reach of the hose 18, and in turn the nozzle 25 from the wheeled work vehicle 1 is extended, see FIG. 16. In this embodiment of the invention the second ram 72 is pivotally coupled to the proximal and distal cross-members 74 and 75, in order to facilitate bending and flexing of the inner telescoping members 72.

The hose 18 is secured to the proximal cross-member 74 by the securing strap 44, and the hose 18 is secured to the distal cross-member 75 by the distal securing strap 45. The hose 18 as discussed above is of concertina construction, and is longitudinally extendable, and a sufficient amount of the hose 18 in the un-extended state is located between the securing strap 44 which secures the hose 18 to the proximal cross-member 44, and the distal strap 45 which secures the hose 18 to the distal cross-member 75, so that when the second ram 79 is fully extended for urging the distal cross-member 75 in the direction of the arrow G relative to the proximal cross-member 74 to fully extend the distal carrier arm 33, the portion of the hose 18 between the securing strap 44 and the distal securing strap 45 is sufficient to allow full extension of the hose 18 when the distal carrier arm 33 is fully extended.

A retaining means for loosely retaining the hose 18 in position on the proximal part 73 of the distal carrier arm 33 comprises a retaining cage 80 secured to the intermediate cross-member 77 and to a secondary cross-member 81 secured to the outer telescoping members 71 intermediate the proximal and distal cross-members 74 and 75. The retaining cage 80 allows for extension and contraction of the hose 18 between the securing strap 44 and the distal securing strap 45 during extension and contraction of the distal carrier arm 33.

Turning now to the holding container 14, the holding container 14 is closed by an upper lid 82 which is hingedly coupled to the holding container 14 about a transversely extending pivot axis 83 by a pair of hinges 87 adjacent a forward end 84 of the holding container 14. The holding container 14 itself is pivotally coupled to a rearward mounting bracket 85 adjacent the rearward end 86 extending upwardly from the housing 12 of the rearward chassis part 4 for facilitating tipping of the holding container 14 for discharging the contents thereof. Two pairs of pivot pins 88 carried on the rearward mounting bracket 85 at respective opposite sides thereof pivotally engage brackets 89 secured to a rear wall 90 of the holding container 14. The pivot pins 88 define a transverse tipping pivot axis 92 about which the holding container 14 is tippable for discharging the contents thereof. A pair of hydraulically powered double acting tipping rams 91 acting between the mounting bracket 85 and the holding container 14 pivots the holding container 14 about the tipping pivot axis 92 in the direction of the arrow K for discharging the contents from the holding container 14. Releasable latches 93 on the rearward end 94 of the upper lid 82 releasably secure the upper lid 82 to the holding container 14.

A control panel 95 illustrated in broken lines in the drivers cab 10 is provided with manual controls 96 for controlling the hydraulic system of the work vehicle 1 through a control circuit 97 illustrated in block representation in broken lines in the drivers cab 10, for in turn operating the hydraulic motor 55 for operating the slewing mechanism 37, the first hydraulic ram 68 for pivoting the distal carrier arm 33 relative to the proximal carrier arm 32 about the first pivot axis 63, and for operating the second ram 79 for extending and contracting the distal carrier arm 33. Such a control circuit for controlling the hydraulic motor and the first and second hydraulic rams 68 and 79 will be well known and understood by those skilled in the art and further description should not be required.

In use, with the hose 18 mounted on the wheeled work vehicle 1 by the apparatus 20, and connected to the inlet port 15 of the holding container 14, the wheeled work vehicle 1 and the apparatus 20 are ready for use for vacuuming litter, rubbish and other debris from a road, pavement, park area or any other surface. With the vacuum drawing unit 16 activated, the wheeled work vehicle is driven forwardly. The litter, rubbish and other debris is drawn through the nozzle 25 and through the hose 18 and in turn through the inlet port 15 into the holding container 14 under the action of the vacuum drawing unit 16. Depending on where the litter, rubbish and other debris to be vacuumed from the surface is relative to the wheeled work vehicle, as the wheeled work vehicle is being driven forwardly, the slewing mechanism 37 is operated for pivoting the proximal carrier arm 32 between the first and second states for in turn directing the nozzle 25 to the litter, rubbish and debris to be collected.

When it is desired to extend the reach of the nozzle 25 from the wheeled work vehicle 1, the first ram 68 is operated to pivot the distal carrier arm 33 upwardly in the direction of the arrow C about the first pivot axis 63, and the second ram 79 is simultaneously operated for urging the distal cross-member 75 relative to the proximal cross-member 74 in the direction of the arrow G to extend the distal carrier arm 33. When the extra reach is no longer required, the first ram 68 is operated for lowering the distal carrier arm 33 in the direction of the arrow D, and the second ram 79 is operated for urging the distal cross-member 75 relative to the proximal cross-member 74 in the direction of the arrow H to contract the distal carrier arm 33.

In the event that as the proximal carrier arm 32, and in turn the distal carrier arm 33 are being pivoted about the main pivot axis 38 in the directions of the arrows A and B between the first and second states, an obstacle or other obstruction is encountered by the nozzle 25 or by the distal end 41 or other part of the distal carrier arm 33, the distal carrier arm 33 pivots in the appropriate direction of the arrows E and F about the second pivot axis 65 and out of the substantially vertically extending plane containing the proximal carrier arm 32, so that the distal carrier arm 33 yields to the obstacle or other obstruction until the obstacle or other obstruction has been cleared by the nozzle 25 or the distal carrier arm as the case may be. At that stage, the action of the tension springs 69 returns the distal carrier arm 33 into the substantially vertically extending plane containing the proximal carrier arm 32.

On completion of the vacuuming up of the litter, rubbish or other debris, or on the holding container 14 being full, the wheeled work vehicle 1 is driven to an area where the contents of the holding container 14 may be discharged. The latches 93 of the upper lid 82 are released, and the holding container 14 is then pivoted about the transverse tipping pivot axis 92 by the tipping rams 91. Since the upper lid 82 is hingedly connected to the holding container 14 about the transverse pivot axis 83 adjacent the forward end of the holding container 14, as the holding container 14 is being pivoted about the transverse tipping pivot axis 92 by the tipping rams 92, the upper lid 82 pivots from the closed state about the transverse pivot axis 83 into an open state to accommodate discharge of the contents from the holding container 14.

If the distal carrier arm 33 is extended, in the event of an obstacle or other obstruction being encountered by the nozzle 25 or the distal end 41 of the distal carrier arm 33, the inner telescoping members 72 of the telescoping elements 70 may flex or bend to allow the nozzle 25 or the distal end 41 of the distal carrier arm 33 to yield until the obstacle or other obstruction has been cleared. If the deflection of the inner telescoping members 72 is insufficient to permit the nozzle 25 or the distal end 41 of the distal carrier arm 33 to clear the obstacle or other obstruction, the distal carrier arm 33 then pivots about the second pivot axis 67 in the appropriate one of the directions of the arrows E and F out of the substantially vertically extending plane containing the proximal carrier arm 32 against the resilient action of the tension springs 69 to thereby permit further yielding of the nozzle 25 or the distal end 41 of the distal carrier arm 33 until the obstacle or other obstruction has been cleared.

While the apparatus 20 according to the invention has been described for mounting the hose on the roof of the driver's cab, it will be readily apparent to those skilled in the art that the apparatus may be adapted for mounting the hose on any other suitable part of the cab. However, it is particularly advantageous to mount the hose with the apparatus 20 mounted on the roof of the cab, since in cases where the wheeled work vehicle comprises a chassis formed in two parts which are pivotal relative to each other about a substantially vertically extending primary pivot axis for steering of the vehicle, accurate control of the location of the nozzle 25 can be maintained as the work vehicle is steered about the primary pivot axis, since the position of the proximal and distal carrier arms, and in turn the nozzle 25 of the hose 18 relative to the cab 10, and in turn relative to forward chassis part remain unchanged as the vehicle is steered.

While the wheeled work vehicle has been described as being of the type comprising a chassis formed by forward and rearward parts which are pivotal about a primary pivot axis, it will be appreciated that in certain cases, the apparatus 20 may be adapted for mounting a hose of a vacuum system or a blower system to a wheeled work vehicle which is formed by a single rigid chassis.

While a particular construction of a carrier means for carrying the hose has been described, it will be readily apparent to those skilled in the art that any other suitable arrangement of carrier arm or carrier arms or indeed other suitable carrier means may be provided. Indeed, it is envisaged in certain cases that the carrier means may comprise a simple carrier arm, or alternatively, the proximal and a distal carrier arms may be rigidly connected relative to each other, and in which case the distal carrier arm would typically extend in a generally downwardly direction from the proximal carrier arm, and may extend downwardly but in a slightly forward direction.

It will also be appreciated that while it is desirable it is not essential that the distal carrier arm be formed by a pair of telescoping elements, in some cases, a single telescoping element may be sufficient comprising a single outer telescoping member and a single inner telescoping member. Indeed, in certain cases, it is envisaged that the distal arm may be of fixed length, and if it is provided to be of variable length, any suitable means besides one or more telescoping elements may be provided for facilitating altering of the length of the distal carrier arm.

Additionally, it will be appreciated that any other suitable main urging means, first urging mean, and second urging means may be provided besides a slewing mechanism and double acting hydraulic rams. It is also envisaged that all the urging means may be electrically powered actuators, and may be either linear actuators or rotary actuators. Indeed, it will also be appreciated that the main urging means may be provided by a linear actuator, for example, an hydraulic ram or an electrically powered linear actuator, or any other suitable rotary actuator.

It is also envisaged that the proximal carrier arm may be configured to be extendable and contractible, and in which case, it is envisaged that the proximal carrier arm may comprise one or more telescoping elements, or other suitable means for altering the length of the proximal carrier arm. In cases where the proximal carrier arm is of variable length, a suitable urging means would be provided for altering the length of the proximal arm, and such an urging means, could, for example, be any suitable actuator be it hydraulically powered or electrically powered, and typically, would be provided by a linear actuator, for example, an hydraulic ram or an electrically powered linear actuator.

It will also be appreciated that while the hydraulic rams have been described as comprising double acting hydraulic rams, single acting hydraulic rams may be provided, and in which case, the single acting hydraulic rams would be provided with a spring return.

While the hose has been described as being connected to a vacuum system, it is also envisaged that the hose may be connected to a blower system which would be adapted to blow litter, rubbish and other debris or other articles of rubbish or otherwise. Needless to say, while the wheeled work vehicle has been described for collecting litter and other debris, the wheeled work vehicle may be used for collecting any material, articles and the like from the ground or other surface, and it is envisaged that as well as litter, due to the diameter of the hose, rubbish, such as bottles of plastics material of the type used for drinking water and beverages could also be vacuumed up from the ground through the nozzle and the hose, and it will of course be appreciated that the wheeled work vehicle may be used for collecting or blowing leaves and other organic matter from the ground.

While the inner telescoping members of the telescoping elements have been described as being of a resilient plastics material, the inner telescoping elements may be of any suitable material, and may be of steel, which may be rigid or slightly resilient.

1-66. (canceled)

67. Apparatus for mounting a hose of one of a vacuum system and a blower system on a wheeled work vehicle, the hose terminating at a distal end in a distal opening, the apparatus comprising a mounting means configured for mounting on a cab of the wheeled work vehicle, a carrier means for carrying the hose, the carrier means being pivotally coupled to the mounting means and being pivotal about a main pivot axis from a first state locating the distal opening of the hose to a first side of the work vehicle, and a second state locating the distal opening of the hose to a second side of the work vehicle, and a main urging means for urging the carrier arm between the respective first and second states.

68. Apparatus as claimed in claim 67 in which a securing means is provided for securing the hose to the carrier means, and preferably, the securing means comprises a releasable securing means for releasably securing the hose to the carrier means, and advantageously, the carrier means terminates in a distal securing means for securing the hose to the carrier means adjacent the distal end of the carrier means, and preferably, the distal securing means comprises a releasable distal securing means for releasably securing the hose to the carrier means adjacent the distal end thereof, and advantageously, the distal securing means is configured for securing the hose to the carrier means towards the distal opening of the hose, and preferably, the carrier means is configured for moving the distal opening of the hose from the first side of the work vehicle to the second side thereof across and in front of the cab as the carrier means is urged between the first and second states through a central state intermediate the first and second states with the carrier means extending in a generally forwardly direction relative to the normal forward direction of motion of the vehicle.

69. Apparatus as claimed in claim 67 in which the mounting means is configured for mounting on the cab of the wheeled work vehicle with the main pivot axis extending substantially vertically, and preferably, the mounting means is configured for mounting on the roof of the cab of the wheeled work vehicle externally of the cab.

70. Apparatus as claimed in claim 67 in which the carrier means comprises a proximal carrier arm extending between a proximal end and a distal end and a distal carrier arm extending between a proximal end and a distal end, the proximal carrier arm being pivotally connected to the mounting means about the main pivot axis adjacent the proximal end thereof, and preferably, the proximal end of the distal carrier arm is connected to the distal end of the proximal carrier arm, and advantageously, the distal carrier arm extends in a generally downwardly direction from the proximal carrier arm, and preferably, the distal carrier arm is pivotally coupled to the proximal carrier arm about a first pivot axis, and is pivotal about the first pivot axis from a first position extending generally downwardly from the proximal carrier arm through an angle relative to the proximal carrier arm with the distal carrier arm extending in a generally forwardly downwardly direction when the carrier means is in the central state, and advantageously, a first urging means is provided for pivoting the distal carrier arm relative to the proximal carrier arm about the first pivot axis.

71. Apparatus as claimed in claim 70 in which the distal carrier arm is pivotally coupled to the proximal carrier arm about a second pivot axis extending substantially orthogonally to the first pivot axis, and is pivotal about the second pivot axis from side to side out of a substantially vertically extending plane containing the proximal carrier arm.

72. Apparatus as claimed in claim 71 in which the distal carrier arm is resiliently retained in the substantially vertically extending plane containing the proximal carrier arm, and preferably, a resilient retaining means is coupled between the distal carrier arm and the proximal carrier arm for resiliently retaining the distal carrier arm in the substantially vertically extending plane containing the proximal carrier arm, and advantageously, the resilient retaining means comprises a pair of tension springs coupled between the proximal and distal carrier arms on respective opposite sides of the second pivot axis.

73. Apparatus as claimed in claim 70 in which the proximal carrier arm extends substantially horizontally, and preferably, the distal securing means is located on the distal carrier arm adjacent the distal end thereof, and advantageously, the distal carrier arm is extendable and contractible between the proximal and distal ends thereof, and preferably, the distal carrier arm comprises a proximal part and a distal part, one of the proximal part and the distal part being slideable relative to the other one of the proximal part and the distal part in a guide means located on the other one of the proximal part and the distal part for extending and contracting the distal carrier arm.

74. Apparatus as claimed in claim 73 in which the distal part of the distal carrier arm is resiliently mounted relative to the proximal part thereof for facilitating flexing of the distal end of the distal carrier arm relative to the proximal end thereof.

75. Apparatus as claimed in claim 73 in which the one of the proximal part and the distal part of the distal carrier arm comprises an outer telescoping member forming the guide means, and the other one of the proximal part and the distal part of the distal carrier arm comprises an inner telescoping member slideable in the outer telescoping member, and preferably, the proximal part of the distal carrier arm comprises the outer telescoping member, and the distal part of the distal carrier arm comprises the inner telescoping member.

76. Apparatus as claimed in claim 75 in which the inner telescoping member comprises a resilient material for permitting flexing of the inner telescoping member, and preferably, the inner telescoping member comprises a resilient plastics material.

77. Apparatus as claimed in claim 75 in which the distal carrier arm comprises a pair of outer telescoping members and a corresponding pair of inner telescoping members extending parallel to each other, and preferably, a second urging means is provided for urging the proximal and distal parts of the distal carrier arm towards and away from each other for contracting and extending the distal carrier arm between the proximal and distal ends thereof, and advantageously, the second urging means is pivotally coupled to the proximal part of the distal carrier arm for accommodating flexing of the distal part of the distal carrier arm relative to the proximal part thereof, and preferably, a plurality of the securing means is provided spaced apart on the carrier means for securing the hose to the carrier means at spaced apart locations along the carrier means.

78. Apparatus as claimed in claim 67 in which the mounting means is configured for resiliently mounting on the roof of the cab by a resilient mounting means.

79. Apparatus as claimed in claim 78 in which the resilient mounting means comprises at least two spaced apart resilient mounting elements, and preferably, the resilient mounting means comprises four spaced apart resilient mounting elements, and advantageously, the mounting means comprises a mounting plate, and preferably, the main urging means comprises a slewing mechanism mounted on the mounting means and defining the main pivot axis, and advantageously, the slewing mechanism comprises a slewing element having external gear teeth engageable with a worm gear for pivoting the slewing element about the main pivot axis, the carrier means being coupled to the slewing element for urging the carrier means between the first and second states, and preferably, the worm gear is driven by a drive motor.

80. A wheeled work vehicle comprising a chassis, a pair of spaced apart forward ground engaging wheels rotatably mounted on the chassis adjacent the forward end thereof, and a pair of spaced apart rearward ground engaging wheels rotatably mounted on the chassis adjacent the rearward end thereof, a cab mounted on the chassis adjacent the forward end thereof, one of a vacuum system and a blower system located on the chassis, and a hose extending from the one of the vacuum system and the blower system, the hose terminating at a distal end thereof in a distal opening, and apparatus as claimed in any preceding claim with the mounting means of the apparatus mounted on the cab and the hose secured to the carrier means.

81. A wheeled work vehicle as claimed in claim 80 in which the mounting means is mounted on the roof of the cab, and preferably, the mounting means is mounted on the cab of the vehicle with the main pivot axis extending substantially vertically, and advantageously, the carrier means and the mounting means are configured so that the carrier means is pivotal relative to the mounting means about the main pivot axis from the first state with the distal opening of the hose located to one side of the cab to the second state with the distal opening of the hose located adjacent the other side of the cab, and preferably, the mounting means is mounted on the cab, so that as the carrier means is being pivoted about the main pivot axis from the first state to the second state through the central state, the distal opening of the hose is urged from one side of the cab to the other side thereof in front of the cab and externally thereof.

82. A wheeled work vehicle as claimed in claim 80 in which an engine is provided in the wheeled work vehicle, and preferably, the chassis comprises a forward chassis part and rearward chassis part pivotally coupled to the forward chassis part about a substantially vertically extending primary pivot axis about which the forward chassis part and the rearward chassis part are pivotal relative to each other for steering of the wheeled work vehicle, and advantageously, the cab is mounted on the forward chassis part, and the one of the vacuum system and the blower system is mounted on the rearward chassis part, and preferably, at least one primary urging means is coupled between the forward and rearward chassis parts for pivoting the one of the forward and rearward chassis parts relative to the other one of the forward and rearward chassis parts for steering the wheeled work vehicle, and advantageously, the primary urging means is located to one side of the primary pivot axis, and preferably, a pair of the primary urging means are provided on respective opposite sides of the primary pivot axis.

83. A wheeled work vehicle as claimed in claim 82 in which the one of the vacuum system and the blower system is located on the rearward chassis part, and preferably, the engine is mounted on the rearward chassis part, and advantageously, the one of the vacuum system and the blower system is located above the engine.

84. A wheeled work vehicle as claimed in claim 80 in which the hose is mounted on the carrier means by the securing means, and preferably, the distal opening of the hose is defined by a distal nozzle in which the distal end of the hose terminates, and advantageously, the hose is secured to the distal end of the carrier means by the distal securing means.

85. A wheeled work vehicle as claimed in claim 80 in which the vacuum system comprises a holding container and a vacuum drawing means located in or adjacent the holding container for drawing a vacuum in the holding container, and the hose is coupled to and communicates with the holding container through an inlet port, and preferably, the engine is configured to drive the rearward ground engaging wheels, and advantageously, the engine is configured to drive the forward ground engaging wheels, and preferably, the engine is configured to drive the ground engaging wheels through an hydraulic transmission system.

86. A wheeled work vehicle as claimed in claim 80 in which a control means is provided for controlling the operation of the main urging means, and preferably, the control means is configured for controlling the operation of the first urging means, and advantageously, the control means is configured for controlling the second urging means, and preferably, the control means is responsive to one or more manually operated elements for controlling the main urging means, the first urging means and the second urging means, and advantageously, the first urging means comprises a first hydraulic ram, and preferably, the second urging means comprises a second hydraulic ram, and advantageously, the vacuum system and the hose are configured for drawing litter, rubbish and other debris from any one of a roadway, a pathway, a park, a recreational area or any other area or surface where litter, rubbish or other debris may collect.
